(19) United States
(12) Patent Application Publication
(10) Pub. No.: US 2012/0080381 A1
(43) Pub. Date: Apr. 5, 2012

(54) THIN FILM COMPOSITE MEMBRANES INCORPORATING CARBON NANOTUBES

(75) Inventors: Hua Wang, Clifton Park, NY (US); Gary William Yeager, Rexford, NY (US); Steven Thomas Rice, Scotia, NY (US)

(73) Assignee: GENERAL ELECTRIC COMPANY, Schenectady, NY (US)

(21) Appl. No.: 12/895,365

(22) Filed: Sep. 30, 2010

(51) Int. Cl. B01D 71/02; B01D 71/68; B05D 1/06; C09D 1/00; C02F 1/44; B01D 71/60; B82Y 30/00; B82Y 40/00

(52) U.S. Cl. 210/654; 210/500.37; 427/244; 106/285; 977/742; 977/840; 977/902; 977/752

(57) ABSTRACT

Processes for manufacturing a thin film composite membrane comprising multi-walled carbon nanotubes include contacting under interfacial polymerization conditions an organic solution comprising a polyacid halide and carbon nanotubes with an aqueous solution comprising a polyamine to form a thin film composite membrane on a surface of a porous base membrane, wherein the organic solution additionally comprises a saturated cyclic C₅-C₂₀ hydrocarbon solvent.

### CROSS-REFERENCE TO RELATED APPLICATIONS

This application is related to U.S. patent application entitled filed concurrently herewith under attorney docket number 238323-1 the entire disclosure of which is incorporated herein by reference.

### BACKGROUND

Reverse osmosis (RO) desalination uses membrane technology to transform seawater and brackish water into fresh water for drinking, irrigation and industrial applications. Reverse osmosis desalination processes require substantially less energy than thermal desalination processes. As a result, the majority of recent commercial projects use more cost-effective reverse osmosis membranes to produce fresh water from seawater or brackish water. Over the years, advances in membrane technology and energy recovery devices have made reverse osmosis more affordable and efficient. Despite its capacity to efficiently remove ionic species at as high as 99.7% salt rejection, there remains a need for reverse osmosis membranes that possess improved flux characteristics while maintaining useful rejection characteristics.

Reverse osmosis is the process of forcing a solvent from a region of high solute concentration through a membrane to a region of low solute concentration by applying a pressure in excess of the osmotic pressure. This is the reverse of the normal osmosis process, which is the natural movement of solvent from an area of low solute concentration, through a membrane, to an area of high solute concentration when no external pressure is applied. The membrane here is semipermeable, meaning it allows the passage of solvent but not of solute. The membranes used for reverse osmosis have a dense barrier layer where most separation occurs. In most cases the membrane is designed to allow only water to pass through this dense layer while preventing the passage of solutes (such as salt ions). Examples of reverse osmosis processes are the purification of brackish water and seawater, where often less than 1% of the impurity species in the seawater or brackish water are found in the permeate. The reverse osmosis process requires that a high pressure be exerted on the high concentration side of the membrane, usually 2-17 bar (30-250 psi) for fresh and brackish water, and 40-70 bar (600-1000 psi) for seawater, which has around 24 bar (350 psi) natural osmotic pressure which must be overcome.

Nanofiltration, in concept and operation, is much the same as reverse osmosis. The key difference is the degree of removal of monovalent ions such as chlorides. Reverse osmosis removes about 99% of the monovalent ions. Nanofiltration membranes removal of monovalent ions varies between 50% to 90% depending on the material and manufacture of the membrane. Nanofiltration membranes and systems are used for water softening, food and pharmaceutical applications. An example of a nanofiltration process is the desalting of a sugar solution, where 80% of the salt passes through the membrane with the water and 95% of the sugar is retained by the membrane.

It is well known that for a given polymer, there is a flux-rejection trade-off curve that defines the upper bound of the flux-rejection relationship. One can obtain high membrane flux with trade-off in terms of salt rejection. On the other hand, one can obtain high membrane salt rejection with trade-off in terms of membrane water permeability. It is highly desirable to obtain membrane materials with performance above the trade-off curve, i.e., achieving both high flux and high salt rejection.

Nanotubes such as carbon and boron nanotubes are fundamentally new nanoporous materials that have great potential for membrane applications. The current methods of synthesis of CNT membranes (Hinds et al Science, 2004; Holt et. al. Science, 2006; Fornasiero et. al., PNAS, 2008) involve multiple steps and are limited to making membrane samples of extremely small area. They are not scalable to large surface areas necessary for the fabrication of commercial membranes for practical applications. Membranes containing carbon nanotubes have been disclosed for use in purifying water. For example, WO 2006/060721, assigned to National University of Singapore, describes thin film composite (TFC) membranes containing multi-walled carbon nanotubes (MWNT) in an active layer prepared by interfacial polymerization. Presently, there is no commercially viable method for NANOTUBE composite membrane and roll-to-roll manufacturing. Thus, a simple, fast, and practical route to make organic-inorganic composite (or hybrid) membrane by integrating NANOTUBEs into current interfacially polymerized RO membrane active layer during interfacial polymerization is desirable.

Such membranes have not been produced commercially, in part because of the limited stability of the dispersions of the nanotubes in coating solutions that are typically used. During fabrication of membranes incorporating nanotubes, it is important that the nanotubes stay uniformly dispersed in the coating solution formulations to ensure that the coated membranes have consistent performance. At the same time, the organic coating solution needs to be compatible with microporous polysulfone support. If the organic coating solution excessively swells or even dissolves the microporous polysulfone support, then the coated RO or NF membranes has poor membrane flux or/and rejection properties. Thus, one of the challenges for commercially viable methods of making RO and NF composite membranes incorporating carbon nanotubes is a stable nanotube-containing organic coating solution that is compatible with the microporous polysulfone support, immiscible with water, and has adequate solubility for the polyfunctional acyl halide monomers.

### BRIEF DESCRIPTION

It has been discovered that use of a polysulfone-insoluble solvent having a density greater than about 0.8 kg/m³ and water solubility of less than about 100 g/L for coating solutions containing nanotubes results in improved stability of the formulation, and enhanced properties of the membranes produced. Accordingly, in one aspect, the present invention relates to processes for manufacturing thin film composite membranes that contain carbon nanotubes wherein an organic solution comprising a polyacid halide and the carbon nanotubes and a polysulfone-insoluble organic solvent having a density greater than about 0.8 kg/m³ and water solubility of less than about 100 g/L is contacted with an aqueous solution comprising a polyamine under interfacial polymerization conditions to form a thin film composite membrane on a surface of a porous base membrane.

In another aspect, the present invention relates to compositions that include carbon nanotubes dispersed in an organic solution comprising a solvent having a density greater than about 0.8 kg/m³ and water solubility of less than about 100 g/L Such compositions may be used for membrane fabrication, or for other purposes.

### DETAILED DESCRIPTION

Solvents for use in the compositions and processes of the present invention have density greater than about 0.8 and solubility in water of less than about 100 g/L. The solvent may be a single compound or a mixture having the specified density and water solubility. Particularly suitable solvents having these properties are cis- and trans-decalin, and mixtures thereof. Solvents for use in the processes of the present invention are additionally insoluble in the polysulfone base membranes commonly used in preparing reverse osmosis membranes. The terms “polysulfone insoluble” and “insoluble in polysulfones” means that such materials swell or dissolve polysulfone. These materials typically contain one or more double or triple bonds, for example, C═C, C═O, and S═O. Examples include cyclohexanone, N-methylpyrrolidone (NMP), dimethyl acetate (DMAc), dimethyl sulfoxide (DMSO) and sulfolane. Polysulfone insoluble materials may be included in compositions of the present invention in minor amounts, that is, less than about 50% by weight, based on total weight of the composition. In some embodiments, the polysulfone insoluble materials are present at less than or equal to about 10% by weight, in others at less than or equal to about 5% by weight, and in still others, less than or equal to about 3% by weight.

Other properties of solvents that may be relevant to nanotube dispersion and/or suitability for use in interfacial polymerization include stability, including viscosity, and boiling point. In some cases, higher viscosity may yield more stable dispersions. It may be desirable for solvents that must be removed from a polymer formed from the compositions of the present invention that the boiling point be relatively low, typically lower that about 200° deg C.

In some embodiments, the solvent is a saturated cyclic C₅-C₂₀ hydrocarbon solvent. In particular embodiments, the saturated cyclic C₅-C₂₀ hydrocarbon solvent is a saturated polycyclic compound, or a mixture or one or more saturated polycyclic compounds, for example, cis-decalin, trans-decalin, cyclohexyl halides, and 1,5,9-cyclododecatrien and derivatives or a mixture thereof.

Compositions of the present invention and organic solutions for use in the processes of the present invention may also include at least one saturated acyclic C₄-C₃₀ alkane compound, such as hexane or one or more isoparaffins. Suitable isoparaffins include the ISOPAR™ series from ExxonMobil (including, but not limited to, ISOPAR™ E, ISOPAR™ G, ISOPAR™ H, ISOPAR™ L, and ISOPAR™ M). The saturated cyclic C₅-C₂₀ hydrocarbon loading in the organic solution is greater than about 20% w/w (weight of saturated cyclic C₅-C₂₀ hydrocarbon/total weight of solvent, not including monomer or nanotubes); in some embodiments, greater than about 50% w/w, and in other embodiments, greater than about 80% w/w.

The organic solution may additionally include a cyclic ketone such as cyclooctanone, cycloheptanone, 2 methylcyclohexanone, cyclohexanone, cyclohexene-3-one, cyclopentanone, cyclobutanone, 3-ketotetrahydrofuran, 3-ketotetrahydrothiophene, or 3-ketoxetane, particularly, cyclohexanone. Aqueous dispersions may include dispersing aids such as polyvinylpyrrolidone, or surfactants, particularly non-ionic surfactants.

Compositions of the present invention and organic solutions for use in the processes of the present invention may also include other additives. The additive loading in the solvent mixture is in the range of 0.1 to 20 wt %, preferably in the range of 0.5% to 10%, and more preferably in the range of 1 to 10%. These other additives include the following compounds with molar volumes in the range of 50 cm3/mol-1 or higher (preferably 80 or higher) and Hildebrand solubility parameters in the range of 8.5 to 10.5 cal^{1/2} cm^{-3/2}: aromatic hydrocarbons such as tetralin, dodecylbenzene, octadecylbenzene, benzene, toluene, xylene, mesitylene, anisole, dimethylbenzenes, trimethylbenzenes, tetramethylbenzene, ethyl-benzene, fluorobenzene, chlorobenzene, bromobenzenes, dibromobenzenes, iodobenzene, nitrobenzene, ethyl-toluene, pentamethyl-benzene, octyl-benzene, cumene, pseudo-cumene, para-cymene, phenetole, and phenoxy-decane; naphthalenes such as methylnaphthalenes, dimethylnaphthalenes, trimethylnaphthalenes, ethylnaphthalenes phenylnaphthalenes, chloronaphthalenes, dichloronaphthalenes, bromonaphthalenes, dibromonaphthalenes nitronaphthalenes, and dinitropyrenes; ketones such as cyclopentanone, cyclohexanone, and alkylcyclohexanones; and conjugated oligomers, polymers, and copolymers, including poly(m-phenylene vinylene), poly(p-phenylene vinylene), poly(3-alkylthiophene), and poly(arylene ethynylene).

Nanotubes for use in the compositions and processes of the present invention include single wall, double wall, and multiwall carbon nanotubes and boron nitride nanotubes with various internal and external diameters and length. Nanotubes with carboxyl (COOH), hydroxyl (OH), carbonyl chloride (—COCl), functionalized with octadecylamine, functionalized with PEG (polyethylene glycol) may be used. Nanotubes with carbonyl chloride (—COCl) may be covalently bonded to polyamide thin film to avoid the leach out of nanotubes during membrane service. The nanotubes typically have a cylindrical nanostructure with an inside diameter (ID) and outside diameters (OD). Concentration of the nanotubes in the organic solution or the aqueous solution is at least 0.025% w/w, and may range from about 0.025% w/w to about 10% w/w in some embodiments, and in others, ranges from about 0.025% w/w to about 5% w/w. In yet other embodiments, the concentration of the nanotubes ranges from about 0.05% w/w to about 1% w/w.

The thin film composite (TFC) membranes that may be prepared by a process according to the present invention are composed of a separating functional layer formed on a porous base support. The separating functional layer is thin in order to maximize membrane flux performance, and is formed on a porous support or base membrane to provide mechanical strength. Examples of TFC membranes that may be prepared include, but are not limited to, reverse osmosis membranes composed of a polyamide separating functional layer formed on a porous polysulfone support, nanofiltration membranes, and other thin film composite membrane.

Interfacial polymerization includes contacting an aqueous solution of one or more nucleophilic monomers onto a porous support membrane; followed by coating an organic solution, generally in an aliphatic solvent, containing one or more electrophilic monomers. At the interface of the two solution layers, which lies near the surface of the porous support, a thin film polymer is formed from condensation of the electrophilic and nucleophilic monomers and is adherent to the porous support. The rate of thin film formation may be accelerated by heating or addition of catalysts. The polyacid halide monomer on contact with the polyamine monomer reacts on the surface of the porous base membrane to afford a polyamide disposed on the surface of the porous support membrane. Suitable monomers useful in the present invention are described below.

As described above, the membrane comprises a polymer having an amine group. The polymer may be produced by interfacial polymerization. Interfacial polymerization includes a process widely used for the synthesis of thin film membranes for reverse osmosis, hyperfiltration, and nanofiltration. Interfacial polymerization includes coating a first solution, generally aqueous, of one or more nucleophilic monomers onto a porous base support; followed by coating a second solution, generally in an aliphatic solvent, containing one or more electrophilic monomers. The second solution is immiscible with the first solution. At the interface of the two solution layers, which lies near the surface of the porous base support, a thin film polymer is formed from condensation of the electrophilic and nucleophilic monomers and is adherent to the porous base support. The rate of thin film formation may be accelerated by heating or addition of catalysts.

Examples of nucleophilic monomers include, but are not limited to, amine containing monomers such as polyethylenimines; cyclohexanediamines; 1,2-diaminocyclohexane; 1,4-diaminocyclohexane; piperazine; methyl piperazine; dimethylpiperazine (e.g. 2,5-dimethyl piperazine); homopiperazine; 1,3-bis(piperidyl)propane; 4-aminomethylpiperazine; cyclohexanetriamines (e.g. 1,3,5-triaminocyclohexane); xylylenediamines (o-, m-, p-xylenediamine); phenylenediamines; (e.g. m-phenylene diamine and p-phenylenediamine, 3,5-diaminobenzoic acid, 3,5-diamonsulfonic acid); chlorophenylenediamines (e.g. 4- or 5-chloro-m-phenylenediamine); benzenetriamines (e.g. 1,3,5-benzenetriamine, 1,2,4-triaminobenzene); bis(aminobenzyl)aniline; tetraminobenzenes; diaminobiphenyls (e.g. 4,4,′-diaminobiphenyl; tetrakis(aminomethyl)methane; diaminodiphenylmethanes; N,N′-diphenylethylenediamine; aminobenzamides (e.g. 4-aminobenzamide, 3,3′-diaminobenzamide; 3,5-diaminobenzamide; 3,5-diaminobenzamide; 3,3′5,5′-tetraminobenzamide); either individually or in any combinations thereof.

Particularly useful nucleophilic monomers for the present invention include m-phenylenediamine, p-phenylenediamine, 1,3,5-triaminobenzene, piperazine, 4-aminomethylpiperidine, and either individually or in any combinations thereof. More particularly, nucleophilic monomer useful in the present invention includes m-phenylene diamine.

Examples of electrophilic monomers include, but are not limited to, acid halide-terminated polyamide oligomers (e.g. copolymers of piperazine with an excess of isophthaloyl chloride); benzene dicarboxylic acid halides (e.g. isophthaloyl chloride or terephthaloyl chloride); benzene tricarboxylic acid halides (e.g. trimesoyl chloride or trimellitic acid trichloride); cyclohexane dicarboxylic acid halides (e.g. 1,3-cyclohexane dicarboxylic acid chloride or 1,4-cyclohexane dicarboxylic acid chloride); cyclohexane tricarboxylic acid halides (e.g. cis-1,3,5-cyclohexane tricarboxylic acid trichloride); pyridine dicarboxylic acid halides (e.g. quinolinic acid dichloride or dipicolinic acid dichloride); trimellitic anhydride acid halides; benzene tetra carboxylic acid halides (e.g. pyromellitic acid tetrachloride); pyromellitic acid dianhydride; pyridine tricarboxylic acid halides; sebacic acid halides; azelaic acid halides; adipic acid halides; dodecanedioic acid halides; toluene diisocyanate; methylenebis(phenyl isocyanates); naphthalene diisocyanates; bitolyl diisocyanates; hexamethylene diisocyanate; phenylene diisocyanates; isocyanato benzene dicarboxylic acid halides (e.g. 5-isocyanato isophthaloyl chloride); haloformyloxy benzene dicarboxylic acid halides (e.g. 5-chloroformyloxy isophthaloyl chloride); dihalosulfonyl benzenes (e.g. 1,3-benzenedisulfonic acid chloride); halosulfonyl benzene dicarboxylic acid halides (e.g. 3-chlorosulfonyl isophthaloyl chloride); 1,3,6-tri(chlorosulfonyl)naphthalene; 1,3,7 tri(chlorosulfonyl)napthalene; trihalosulfonyl benzenes (e.g. 1,3,5-trichlorosulfonyl benzene); and cyclopentanetetracarboxylic acid halides, either individually or in any combinations thereof.

Particular electrophilic monomers include, but are not limited to, terephthaloyl chloride, isophthaloyl chloride, 5-isocyanato isophthaloyl chloride, 5-chloroformyloxy isophthaloyl chloride, 5-chlorosulfonyl isophthaloyl chloride, 1,3,6-(trichlorosulfonyl)naphthalene, 1,3,7-(trichlorosulfonyl)napthalene, 1,3,5-trichlorosulfonyl benzene, either individually or in any combinations thereof. More particular electrophilic monomers include trimesoyl chloride acid chloride

The interfacial polymerization reaction may be carried out at a temperature ranging from about 5° C. to about 60° C., preferably from about 10° C. to about 40° C. to produce an interfacial polymer membrane. Examples of interfacial polymers produced therefrom include polyamide, polysulfonamide, polyurethane, polyurea, and polyesteramides, either individually or in any combinations thereof.

In one example, for illustration and not limitation, a porous base support includes a support material having a surface pore size in the approximate range from about 50 Angstroms to about 5000 Angstroms. The pore sizes should be sufficiently large so that a permeate solvent can pass through the support without reducing the flux of the composite. However, the pores should not be so large that the permselective polymer membrane will either be unable to bridge or form across the pores, or tend to fill up or penetrate too far into the pores, thus producing an effectively thicker membrane than 200 nanometers. U.S. Pat. No. 4,814,082 (W. J. Wrasidlo) and U.S. Pat. No. 4,783,346 (S. A. Sundet) are illustrative of methods of choosing and preparing a porous base support for interfacial TFC (thin film composite) membrane formation.

Non-limiting examples of the material forming the porous base support include polysulfone, polyether sulfone, polyacrylonitrile, cellulose ester, polypropylene, polyvinyl chloride, polyvinylidene fluoride and poly(arylether) ketones. Other porous materials might be used as well, such as ceramics, glass and metals, in a porous configuration. A wide variety of suitable porous base membranes are either available commercially or may be prepared using techniques known to those of ordinary skill in the art. In some embodiments, a porous base membrane which is a polysulfone membrane or a porous polyethersulfone membrane are used because of their desirable mechanical and chemical properties. Those of ordinary skill in the art will be able to make the selection from among the suitable materials.

The thickness of the material forming the porous base support may be between about 75 and about 250 microns thick, although other thicknesses may be used. For example, a 25 microns thick porous base support permits production of higher flux films. In some cases, the porous base support may be relatively thick, for example, 2.5 cm or more, where aqueous solution is applied to only one side, which is subsequently contacted with the organic solution, forming the interface at which polymerization occurs. The polymeric porous base support may be reinforced by backing with a fabric or a non-woven web material. Non-limiting examples include films, sheets, and nets such as a nonwoven polyester cloth. The polymer of the porous base support may permeate through the pores, be attached on both sides of the support, or be attached substantially on one side of the support.

In order to improve permeability and/or salt rejection, the thin film composite membrane may be post-treated with an oxidizing solution, such as a sodium hypochlorite solution. The concentration of sodium hypochlorite in the solution may range from about 50 ppm to about 4000 ppm, and, in some embodiments, from about 50 ppm to about 500 ppm.

In some embodiments, it may be desirable to utilize an in-line, continuous mixer/homogenizer. In one embodiment, a dispersion of nanotubes may be mixed with the monomer-containing solutions prior to use in the coating operation using an in-line, continuous mixer/homogenizer in the processes of the present invention in order to maximize stability of the nanotube dispersions. Generally, a higher-volume stream of the monomer solution is mixed with a lower volume stream of the carbon dispersion to form a dispersion containing both nanotubes and one of the monomers just before the combined coating solution mixture is dispensed on the porous support membrane. Suitable mixing/homogenizing devices include static mixers, ultrasonic mixers, dynamic mixers, and other mechanical devices such as industrial mixers and blenders with various types of blades, shafts, and impellers. Static mixers and ultrasonic mixers are examples of preferred devices due to their simplicity and effectiveness.

The nanotubes dispersion may be under constant or intermittent mixing during the coating operation to ensure the homogeneous dispersion of nanotubes in the coating solution(s). The mixing device includes (but not limited to) ultrasonic mixing device, dynamic mixer, and other mechanical devices such as industrial mixers and blenders with various types of blades, shafts, and impellers to make a good quality homogeneous mixture. Ultrasonic mixing is one of the preferred methods.

The advantage of separating the nanotube dispersion from the monomer solution is that it decouples the various (and often conflicting) requirements of nanotube dispersion stability and solvent compatibility with the porous support. For example, conventional coating formulation (including conventional solvents such as hexane and ISOPAR™ G) may be used in the monomer solution(s), while more aggressive solvents that are better at dispersing nanotubes may be used in making the nanotube dispersion prior to combining the two. Since the residence time between the in-line mixing and the coating is minimized, the nanotubes in the dispersion do not have time to agglomerate and segregate. Also, since the solvent used in dispersing nanotubes is typically a minor fraction in the final coating formulation after the in-line mixing, the problem of solvent attacking the porous support is resolved.

Coating methods typically include dip coating, slot die coating, and spray coating. In some embodiments, when dip coating or slit die coating is used for both aqueous and organic coating solutions, the coating tanks may be used as catch pans to recycle the unused coating solutions. The nanotube dispersions may in-line homogenized outside the coating tanks and recirculated/replenished during the coating operation.

### EXAMPLES

The following examples illustrate a process according to the present invention.

### General Methods

Membrane Fabrication Using Handframe Coating Apparatus: Composite membranes were also prepared using a handframe coating apparatus consisting of a matched pair of frames in which the porous base membrane could be fixed and subsequently coated with a polyamide coating comprising carbon nanotubes. The following procedure was used. The porous base membrane was first soaked in deionized water for at least 30 minutes. The wet porous base membrane was fixed between two 8 inch by 11 inch stainless steel frames and kept covered with water until further processed. Excess water was removed from the porous base membrane and one surface of the porous base membrane was treated with 200 grams of an aqueous solution comprising meta-phenylenediamine (2.6% by weight), amine salt of triethylamine and camphorsulfonic acid (TEACSA 6.6% by weight), the upper portion of the frame confining the aqueous solution to the surface of the porous base membrane. After a period of 30 seconds, the aqueous solution was removed from the surface of the porous base membrane by tilting the assembly comprising the frame and the treated porous base membrane until only isolated drops of the aqueous solution could be observed on the surface of the treated porous base membrane. The treated surface was further treated by exposure to a gentle stream of air to remove isolated drops of the aqueous solution. The treated surface of the porous base membrane was then contacted with 100 grams of an organic solution comprising trimesoyl chloride (0.16% by weight) and carbon nanotubes in ISOPAR™ G solvent for 1 minute in a horizontal position. Prior to application of the organic solution, the organic solution containing carbon nanotubes was first sonicated using a bath sonicator (Branson 5510 model) for 60 minutes and then let stand for 20 minutes. Excess organic solution was then removed by tilting a corner of the frame and collecting the excess organic solution in a suitable collection vessel. The treated assembly was then placed in a drying oven and maintained at a temperature of 90° C. for a period of about 6 minutes after which the composite membrane was ready for testing.

Membrane Fabrication Using Web Coating Apparatus: Membranes were fabricated by depositing a polyamide thin film layer over a porous polysulfone ultrafiltration (UF) support (the porous base membrane) using polyamide interfacial polymerization chemistry. A wet polysulfone UF support web configured on a standard web coating apparatus was drawn through a first dip-coating tank containing an aqueous solution of meta-pheneylene diamine (mPD) solution (Solution A). Excess aqueous solution on top of the support web was removed by a rubber nip roller assembly and an air-knife. Thereafter, the web was drawn through a second dip-coating tank comprising an organic solution (Solution B) of trimesoyl chloride (TMC) in a saturated hydrocarbon solvent or solvent mixture. In experiments in which embodiments of the present invention were produced, this organic solution comprised, in addition to the TMC, containing decalins, and/or organic additive having a molar volume in the range of about 50 cm3/mol-1 or higher and Hildebrand solubility parameters from about 8 to about 12 cal1/2 cm-3/2. Contact on the porous base membrane (the support web) between the Solution A and Solution B resulted in interfacial polymerization of the mPD and TMC components to provide a polyamide coating disposed on the porous base membrane. The product composite membrane was then dried in a drying oven and thereafter wound upon a spool until needed.

Porous base membranes were prepared using a phase inversion method (R. E. Kesting, 1971, Synthetic Polymeric Membranes, McGraw-Hill) in which a thin film of a polysulfone solution is solidified by immersion in a bath containing water, which acts as a nonsolvent for the polymer. Thus, a casting solution comprising ULTRASAN S 6010 polysulfone (BASF) was prepared by dissolution of the polymer in a mixture comprising dimethyl formamide (DMF) and ethyleneglycol monomethylether. The casting solution comprised about 16.3 percent by weight (wt %) polysulfone polymer and 8 percent by weight ethyleneglycol monomethylether with the balance being DMF. The casting solution was metered out onto a reinforcing non-woven polyester fabric support web and the coated support was immersed in a water bath to provide a porous polysulfone film. Residual solvent was removed from the porous polysulfone film by washing the porous polysulfone film with water. The porous polysulfone films, also referred to as polysulfone ultrafiltration (UF) membranes, were kept wet until used. The porous polysulfone films prepared in this manner were useful as the porous base membrane component of the composite membranes provided by the present invention.

Membrane Performance Testing: Membrane tests were carried out on composite membranes configured as a flat sheet in a cross-flow test cell apparatus (Sterlitech Corp., Kent Wash.) (model CF042) with an effective membrane area of 35.68 cm2. The test cells were plumbed two in series in each of 6 parallel test lines. Each line of cells was equipped with a valve to turn feed flow on/off and regulate concentrate flow rate, which was set to 1 gpm (gallon per minute) in all tests. The test apparatus was equipped with a temperature control system that included a temperature measurement probe, a heat exchanger configured to remove excess heat caused by pumping, and an air-cooled chiller configured to reduce the temperature of the coolant circulated through the heat exchanger.

Composite membranes were first tested with a fluorescent red dye (rhodamine WT from Cole-Parmer) to detect defects. A dye solution comprising 1% rhodamine red dye was sprayed on the polyamide surface of the composite membrane and allowed to stand for 1 minute, after which time the red dye was rinsed off. Since rhodamine red dye does not stain polyamide, but stains polysulfone strongly, a defect-free membrane should show no dye stain after thorough rinse. On the other hand, dye stain patterns (e.g. red spots or other irregular dye staining patterns) indicate defects in the composite membranes. The membranes were cut into 2 inch×6 inch rectangular coupons, and loaded into cross flow test cells. Three coupons (3 replicates) from each type of membranes were tested under the same conditions and the results obtained were averaged to obtain mean performance values and standard deviations. The membrane coupons were first cleaned by circulating water across the membrane in the test cells for 30 minutes to remove any residual chemicals and dyes. Then, synthetic brackish water containing 2000 ppm sodium chloride was circulated across membrane at 225 psi and 25° C. The pH of the water was controlled at pH 7.0-7.5. After one hour of operation, permeate samples were collected for 10 minutes and analyzed.

After the initial test period, test coupons were exposed to 70 ppm of sodium hypochlorite at 25° C. for 30 minutes. The test coupons were then rinsed with deionized water for 1 hour. Following this “chlorination” procedure the test coupons were again tested for reverse osmosis membrane performance with the synthetic feed solution containing 2000 ppm sodium chloride used before as described herein. Solution conductivities and temperatures were measured with a CON 11 conductivity meter (Oakton Instruments). Conductivity was compensated to measurement at 25° C. The pH was measured with a Russell RL060P portable pH meter (Thermo Electron Corp).

Permeate was collected in a graduated cylinder. The weight of the permeate collected was determined on Navigator balance and time intervals were recorded with a Fisher Scientific stopwatch. Membrane permeability, expressed in terms of “A value”, was calculated in each case. The A values obtained represent the permeability of water through the membrane and were measured at standard temperature (77 F or 25° C.). A values reported herein have units of 10⁻⁵ cm³/s-cm²-atm. A values were calculated from permeate weight, collection time, membrane area, and transmembrane pressure. Salt concentrations in the permeate and the feed solutions were measured by conductivity to give salt rejection values.

In certain instances, the product composite membrane was rinsed with hot deionized water and stored in a refrigerator before until testing or element fabrication. In one embodiment, the product composite membrane was treated with a solution containing polyvinyl alcohol solution and then dried before storage, testing, or element fabrication.

Dispersion Instability Comparative Examples and Dispersion Stability Examples

### Comparative Example 1

### Instability of CNT Dispersions in ISOPAR™ G, Hexane, and Cyclohexane

0.01% single wall carbon nanotubes (P-3 from Carbon Solutions) were dispersed in ISOPAR™ G by first sonicating for 60 minutes using a bath sonicator (Branson 5510 model) in a glass vial with screw cap. Also, 0.01 wt % multiwall carbon nanotubes with inside diameters of 2-5 nm and outside diameters of less than 8 nm, and a length of 0.5 to 2 mm (1225YJS from Nanostructured and Amorphous Materials, Inc) were dispersed in ISOPAR™ G, hexane, and cyclohexane. After the sonication stopped, the dispersion instability was observed and the results are shown in FIGS. 1 & 2 in previous section and FIGS. 3-5. These carbon nanotube dispersions started to destabilize within minutes and were substantially segregated in less than 20 minutes (Table 2).

TABLE 2

| | | | | Dispersion |
|---|---|---|---|---|
| | CNT type | CNT loading | Solvent | stability |
| Comparative | SWCNT | 0.01% | ISOPAR ™ G | Poor |
| Example 1 | | | | |
| Comparative | MWCNT | 0.01% | Hexane | Very Poor |
| Example 2 | | | | |
| Comparative | MWCNT | 0.01% | Cyclohexane | Poor |
| Example 3 | | | | |
| Comparative | MWCNT | 0.01% | ISOPAR ™ G | Poor |
| Example 4 | | | | |
| Comparative | MWCNT | 0.1% | ISOPAR ™ G | Poor |
| Example 5 | | | | |

Very poor: visible aggregation and phase segregation of CNT dispersion occurred within 10 minutes after the sonication stopped.
Poor: visible aggregation and phase segregation of 0CNT dispersion occurred at 10-20 minutes after the sonication stopped
Fair: visible aggregation and phase segregation of CNT dispersion occurred at 20-30 minutes after the sonication stopped
Good: visible aggregation and phase segregation of CNT dispersion occurred at 31-45 minutes after the sonication stopped.
Excellent: No visible aggregation and phase segregation of CNT dispersion occurred within 45 minutes after the sonication stopped.

### Examples 1-2

### Stability of CNTs Dispersions in Decalin Mixtures

0.01 wt % multiwall carbon nanotubes (1225YJS) were dispersed in a decalins or decalins/ISOPAR™ G mixture by first sonicating for 60 minutes using a bath sonicator (Branson 5510 model) inside a glass vial. After the sonication stopped, the dispersion stability was observed and the results observed. These carbon nanotube dispersions showed no visible segregation within 90 minutes. Thus the dispersion in these decalin mixtures all showed excellent stability (Table 3).

TABLE 3

| | CNT | | Dispersion |
|---|---|---|---|
| Entry | loading | Solvent | stability |
| Example 1 | 0.01% | Decalins (cis- and | Excellent |
| | | trans- mixture) | |
| Example 2 | 0.01% | Decalins/ISOPAR ™ G | Good |
| | | 50:50 mixture | |

### Example 3

### Stability of CNTs Dispersions in Decalin, Cyclohexanone, and their Mixtures

0.1 wt % multiwall carbon nanotubes (1225YJS) were dispersed in a variety of decalins/ISOPAR™ G mixtures by first sonicating for 60 minutes using a bath sonicator (Branson 5510 model) in a glass vial. After the sonication stopped, the dispersion stability was observed. The dispersions in these decalin mixtures showed fair stability.

TABLE 4

| | CNT | | Dispersion |
|---|---|---|---|
| | loading | Solvent | stability |
| Example3 | 0.1% | Decalins (cis- and | Fair |
| | | trans- mixture) | |

### Examples 4-5

### Stability of CNTs Dispersions in Cyclohexanone and ISOPAR™ G

Multiwall carbon nanotubes (1225YJS) at 0.01 wt % loading were dispersed in a variety of cyclohexanone/ISOPAR™ G, mixtures by first sonicating for 60 minutes using a bath sonicator (Branson 5510 model) inside a glass vial with screw cap. After the sonication stopped, the dispersion instability was observed. These carbon nanotube dispersions showed no visible segregation within 30 minutes. Thus the carbon nanotube dispersions in these decalin mixtures showed excellent stability (Table 5).

TABLE 5

| | CNT | | Dispersion |
|---|---|---|---|
| | loading | Solvent | stability |
| Example 4 | 0.01% | ISOPAR ™ G/Cyclohexanone | Excellent |
| | | 90:10 mixture | |
| Example 5 | 0.01% | ISOPAR ™ G/Cyclohexanone | Good |
| | | 97:3 mixture | |

### Examples and Comparative Examples for Membrane Fabricated Using Handframe Coating Apparatus

### Comparative Example 6

A polyamide coated thin film composite RO membrane was fabricated using a handframe apparatus. An aqueous coating solution (Solution A, nominally 90.8 wt % water) was prepared and contained 2.6 wt % meta-phenylene diamine (mPD), and 6.6 wt % triethylammonium camphorsulfonate (TEACSA). An organic coating solution (Solution B) was prepared and contained 0.16 wt % trimesoyl chloride (TMC) in ISOPAR™ G. Using a handframe apparatus and following the General Polymerization Procedure described in the General Methods Section, a wet polysulfone porous support film was first coated with the aqueous solution containing the m-phenylenediamine (Solution A) and then coated with the organic solution comprising the trimesoyl chloride (Solution B) to effect an interfacial polymerization reaction between the diamine and the triacid chloride at one surface of the polysulfone porous support film, thereby producing a thin film composite reverse osmosis membrane. The product membrane was tested in triplicate as described in this section using a solution of magnesium sulfate (2000 ppm in NaCl) at an applied operating pressure of 225 pounds per square inch (psi) and operating crossflow rate of 1.0 gallons per minute (gpm), at pH 7.0. The test results are shown in Table 6.

Following the test, the membrane was contacted with an aqueous solution containing to 70 parts per million (ppm) of sodium hypochlorite at 25° C. for 30 minutes. The membrane was then rinsed with water for 1 hour, and then tested again with the magnesium sulfate solution under the same conditions used previously (2000 ppm NaCl, operating pressure 225 psi and operating crossflow rate of 1.0 gpm, pH 7.0, ambient temperature to provide the data in Table 6 labeled “Membrane A Value (after chlorination)” and “% Salt Passage (after chlorination)”.

TABLE 6

| | Membrane | % Salt | Membrane | % Salt |
|---|---|---|---|---|
| | A Value | Passage | A Value | Passage |
| | (before | (Before | (after | (After |
| | chlori- | chlori- | chlori- | chlori- |
| | nation) | nation) | nation) | nation) |
| Comparative | 3.75 | 0.56 | 4.51 | 0.36 |
| Example 6 | | | | |

### Comparative Examples 7-9

Polyamide thin film composite RO membranes were fabricated as in Comparative Example 1 with the exception that the organic coating solvent (Solution B) were made of decalins, 50:50 decalin/ISOPAR™ G mixture, and 97:3 decalins/cyclohexanone mixture, respectively. The product composite membranes were tested and membrane A-values and salt passage properties were measured. Data are gathered in Table 7. The data show that when the organic coating solution contains carbon nanotubes performance is enhanced relative to a control (Comparative Example 6)

TABLE 7

| | | Membrane | % Salt | Membrane | % Salt |
|---|---|---|---|---|---|
| | | A Value | Passage | A Value | Passage |
| | | (before | (before | (after | (after |
| | Organic | chlori- | chlori- | chlori- | chlori- |
| | solvent | nation) | nation) | nation) | nation) |
| Comparative | 100% | 3.31 | 0.33 | 3.68 | 0.23 |
| Example 7 | decalins | | | | |
| Comparative | 50:50 | 3.70 | 0.28 | 4.56 | 0.21 |
| Example 8 | decalins/ | | | | |
| | ISOPAR ™ G | | | | |
| Comparative | 97:3 | 6.10 | 1.09 | 6.83 | 0.72 |
| Example 9 | ISOPAR ™ G/ | | | | |
| | cyclohexa- | | | | |
| | none | | | | |

### Comparative Examples 10-12

Polyamide thin film composite RO membranes were fabricated as in Comparative Example 1 with the exception that the organic coating solution (Solution B) further comprised 0.025, 0.05, and 0.1 wt % multiwall carbon nanotubes (1225YJS). The product composite membranes were tested and membrane A-values and salt passage properties were measured. Data are gathered in Table 8. The data show that when the organic coating solution contains carbon nanotubes performance was enhanced relative to a control (Comparative Example 6)

TABLE 8

| | | Membrane | % Salt | Membrane | % Salt |
|---|---|---|---|---|---|
| | | A Value | Passage | A Value | Passage |
| | | (before | (before | (after | (after |
| | CNT | chlori- | chlori- | chlori- | chlori- |
| | wt % | nation) | nation) | nation) | nation) |
| Comparative | 0.025 | 5.00 | 0.81 | 5.37 | 0.39 |
| Example 10 | | | | | |
| Comparative | 0.05 | 5.90 | 0.92 | 7.53 | 0.40 |
| Example 11 | | | | | |
| Comparative | 0.1 | 6.35 | 0.32 | 9.88 | 0.31 |
| Example 12 | | | | | |

### Examples 6-7

Polyamide thin film composite RO membranes were fabricated as in Comparative Example 1 with the exception that the solvent of the organic coating solution (Solution B) comprising a 50:50 mixture of ISOPAR™ G and decalins (Example 1) or 100% decalins (Example 3) and the solution also comprising 0.05 wt % (Example 1) and 0.1 wt % (Example 2) of MWCNT (1225YJS). The product composite membranes were tested and membrane A-values and salt passage properties were measured. Data are gathered in Table 9. The data show that when the CNT was better dispersed in the organic coating solutions, performance of the product composite membrane was enhanced relative to the controls (Comparative Examples 6 and 9). Comparative Examples 6 and 9 are included in Table 9 for convenience.

TABLE 9

| | | | Before Treatment of | | | After Treatment of | | |
|---|---|---|---|---|---|---|---|---|
| | | | Membrane with | | | Membrane with | | |
| | | | Hypochlorite | | | Hypochlorite | | |
| | | | | A value | | | A value | |
| | Organic | MWCNT | | inc over | % Salt | | inc over | % Salt |
| | Solvent | (wt/wt %) | A Value | control | Passage | A Value | control | Passage |
| Comparative | ISOPAR ™ G | 0 | 3.75 | | 0.56 | 4.51 | | 0.36 |
| Example 6^{†} | | | | | | | | |
| Comparative | ISOPAR ™ G | 0.1% | 6.35 | 69.34% | 0.32 | 9.88 | 118.82% | 0.31 |
| Example 12^{†} | | | | | | | | |
| Example 6* | 50:50 | 0.1% | 8.96 | 139.01% | 0.42 | 13.7 | 203.68% | 0.46 |
| | Decalins/ISOPAR ™ G | | | | | | | |
| Example 7** | Decalins | 0.1% | 7.95 | 111.89% | 0.64 | 12.36 | 173.76% | 0.47 |

^{†}Comparative Example 6 contained ISOPAR ™ G as organic solvent.
^{††}Comparative Example 12 contained ISOPAR ™ G as organic solvent and 0.1 wt % MWCNT.
*Organic coating solution (Solution B) comprising of 50:50 decalin as solvent.
**Organic coating solution (Solution B) comprising of 100% decalins as solvent

### Example 8

Polyamide thin film composite RO membranes were fabricated as in Comparative Example 1 with the exception that the solvent of the organic coating solution (Solution B) comprising a 97:3 mixture of ISOPAR™ G and cyclohexanone and 0.05 wt % of MWCNT (1225YJS). The product composite membranes were tested and membrane A-values and salt passage properties were measured. Data are gathered in Table 10. The data show that when the CNT dispersion in organic coating solutions are more stable, performance of the product composite membrane is enhanced relative to the controls (Comparative Examples 3 and 4) containing only one performance enhancing additive in either the aqueous or the organic solution. Comparative Examples 6 and 12 are included in Table 10 for convenience.

TABLE 10

| | | | Before Treatment of | | | After Treatment of | | |
|---|---|---|---|---|---|---|---|---|
| | | | Membrane with | | | Membrane with | | |
| | | | Hypochlorite | | | Hypochlorite | | |
| | | | | A value | | | A value | |
| | Organic | MWCNT. | | inc over | % Salt | | inc over | % Salt |
| | Solvent | (wt/wt %) | A Value | control | Passage | A Value | control | Passage |
| Comparative | ISOPAR ™ G | 0 | 3.75 | | 0.56 | 4.51 | | 0.36 |
| Example 6^{†} | | | | | | | | |
| Comparative | ISOPAR ™ G | 0.05% | 5.90 | 55.35% | 0.92 | 7.53 | 66.79% | 0.40 |
| Example 12^{†} | | | | | | | | |
| Example 8* | 97:3 | 0.05% | 6.70 | 78.68% | 0.22 | 10.05 | 122.64% | 0.22 |
| | ISOPAR ™ G/cyclohexanone | | | | | | | |

^{†}Comparative Example 6 contained ISOPAR ™ G as organic solvent.
^{††}Comparative Example 12 contained ISOPAR ™ G as organic solvent and 0.1 wt % MWCNT.
*Organic coating solution (Solution B) comprising of 97:3 ISOPAR ™ G/cyclohexanone mixture as solvent.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A process for manufacturing a thin film composite membrane comprising carbon nanotubes, said process comprising contacting under interfacial polymerization conditions an organic solution comprising a polyacid halide and the carbon nanotubes with an aqueous solution comprising a polyamine to form a thin film composite membrane on a surface of a porous base membrane,
wherein the organic solution additionally comprises a saturated cyclic C₅-C₂₀ hydrocarbon solvent.

2. A process according to claim 1, wherein the organic solution additionally comprises at least one saturated acyclic C₄-C₃₀ alkane compound.

3. A process according to claim 2, wherein the at least one saturated acyclic C₄-C₃₀ alkane compound is an isoparaffin.

4. A process according to claim 1, wherein the saturated cyclic hydrocarbon solvent comprises at least one saturated polycyclic compound.

5. A process according to claim 1, wherein the saturated cyclic C₅-C₂₀ hydrocarbon solvent is cis-decalin, trans-decalin, or a mixture thereof.

6. A process according to claim 1, wherein the saturated cyclic C₅-C₂₀ hydrocarbon solvent is cis-decalin, trans-decalin, or a mixture thereof and the saturated non-cyclic alkane is an isoparaffin.

7. A process according to claim 1, wherein the organic solution comprises greater than about 20% w/w of the saturated cyclic C₅-C₂₀ hydrocarbon solvent.

8. A process according to claim 1, wherein the organic solution comprises greater than about 50% w/w of the saturated cyclic C₅-C₂₀ hydrocarbon solvent.

9. A process according to claim 1, wherein the organic solution comprises greater than about 80% w/w of the saturated cyclic C₅-C₂₀ hydrocarbon solvent.

10. A process according to claim 1, wherein the carbon nanotubes are multi-walled carbon nanotubes.

11. A process according to claim 1, wherein the polyacid halide is trimesoyl chloride.

12. A process according to claim 1, wherein the polyamine is para-phenylene diamine.

13. A process for manufacturing a thin film composite membrane comprising carbon nanotubes, said process comprising contacting under interfacial polymerization conditions an organic solution comprising a polyacid halide and the carbon nanotubes with an aqueous solution comprising a polyamine to form a thin film composite membrane on a surface of a porous base membrane,
wherein the organic solution additionally comprises a polysulfone-insoluble solvent having a density greater than about 0.8 kg/m³ and water solubility of less than about 100 g/L.

14. A process according to claim 13, wherein the polysulfone-insoluble solvent is cis-decalin, trans-decalin, or a mixture thereof.

15. A process according to claim 13, wherein the organic solution is a solvent blend having a density greater than about 0.8 kg/m³, and additionally comprises a solvent having water solubility of less than about 100 g/L

16. A process according to claim 13, wherein the organic solution additionally comprises a saturated non-cyclic C₄-C₃₀ alkane is an isoparaffin.

17. A process according to claim 12, wherein the saturated non-cyclic C₄-C₃₀ alkane is an isoparaffin.

18. A thin film composite membrane prepared by the process of claim 1.

19. A reverse osmosis element comprising a thin film composite membrane according to claim 14.

20. A desalination system comprising at least one reverse osmosis element according to claim 15.

21. A desalination process comprising contacting seawater or brackish water with a thin film composite membrane according to claim 14.

22. A composition comprising carbon nanotubes dispersed in an organic solution comprising a solvent having a density greater than about 0.8 kg/m³ and water solubility of less than about 100 g/L.
